(19) United States
(12) Patent Application Publication
(10) Pub. No.: US 2009/0114540 A1
(43) Pub. Date: May 7, 2009

(54) Electro-Osmotic Dehydrator

(75) Inventor: Yeong Chae Lee, Busan (KR)

Correspondence Address: OLIFF & BERRIDGE, PLC, P.O. BOX 320850, ALEXANDRIA, VA, 22320-4850, US

(73) Assignee: Samwoointec Inc., Busan (KR)

(21) Appl. No.: 12/226,061

(22) PCT Filed: Sep. 4, 2006
(86) PCT No.: PCT/KR2006/003497

§ 371 Date: Oct. 7, 2008

(51) Int. Cl. C02F 11/12

(52) U.S. Cl. 204/600

(57) ABSTRACT

Disclosed is an electro-osmotic dehydrator dehydrating sludges generated from the treatment plants of, such as, pure water, sewage water, night soil, waste water, etc. using three phase alternating current.

More particularly, the present invention is directed to an electro-osmotic dehydrator using three phase alternating current having three technical configurations as described below.
(i) An electrode allowing voltage to be applied to a drum and a caterpillar comprises a spring and a graphite elastic supported by the spring, such that stable contact is possible regardless of the amount or constellation of sludges, and even abrasions of the electrode are progressing, the contact maintains always constant, thereby persisting the function of dehydration.
(ii) Further, a phase control for three phase alternating current is possible with each phase to prevent the voltage drop during dehydration time, and even a large capacity of current is applied thereto, it can be used by dropping the voltage to various optimum voltages suitable for a constellation of sludges, such that various constellation of sludges can be dehydrated with a wide range of applications, thereby the present invention employs such phase control configurations for three phase alternating current.
(iii) In addition, after dehydrating sludges, there arise improvements of dehydration and energy efficiencies of an apparatus for rinsing a filtration cloth belt rinsing the filtration cloth belt used in the dehydration, a spray nozzle is configured to a spiral type nozzle to prevent the blocking of the nozzle.

### TECHNICAL FIELD

The present invention relates to an electro-osmotic dehydrator dehydrating sludges generated from the treatment plants of, such as, pure water, sewage water, night soil, waste water, etc. using three phase alternating current.

More particularly, the present invention is directed to an electro-osmotic dehydrator using three phase alternating current having three technical configurations as described below.

(i) An electrode allowing voltage to be applied to a drum and a caterpillar comprises a spring and a graphite elastic supported by the spring, such that stable contact is possible regardless of the amount or constellation of sludges, and even abrasions of the electrode are progressing, the contact maintains always constant, thereby persisting the function of dehydration.
(ii) Further, a phase control for three phase alternating current is possible with each phase to present the voltage drop during dehydration time, and even a large capacity of current is applied thereto, it can be used by dropping the voltage to various optimum voltages suitable for a constellation of sludges, such that various constellation of sludges can be dehydrated with a wide range of applications, thereby the present invention employs such phase control configurations for three phase alternating current.
(iii) In addition, after dehydrating sludges, there arise improvements of dehydration and energy efficiencies of an apparatus for rinsing a filtration cloth belt rinsing the filtration cloth belt used in the dehydration, a spray nozzle is rotated by regular angle right and left, and a rinsing water spray nozzle is configured to a spiral type nozzle to prevent the blocking of the nozzle.

### BACKGROUND ART

Industrial waste water generated from domestic sewage water or various industrial complexes is collected in treatment plants, and various pollutants contained therein are purified and disposed.

The water separated from the treatment process for such waste water is recycled and disposed.

The remnant sludges are difficult to be treated due to its large water content, and high weight thereof increases the treatment cost, thereby reducing the amount of treatment by dehydrating and drying.

A dehydrating process according to the apparatus for dehydrating such sludges, comprises that sludges separated from waste water is introduced into a stirring tank with a polymer aggregating agent to react to thereby from a floc suitable for dehydrating, and then conveyed through inlet of the dehydrator to a dehydrating part.

Dehydration part is configured for the filtration cloth belt of the upper and lower part thereof to rotate, sludges between the upper and lower filtration cloth belt is introduced, and the water is removed by electrophoresis. In order to form an electric field therefor, direct current is applied to the filtration cloth belts, and then the water contained in the sludges is dewatered by its voltages difference.

That is, the dehydration part of conventional electro-osmotic dehydrator comprises a drum to which a anode (+) is applied, a caterpillar which is established and spaced apart from the drum and to which a cathode (−) is applied, and two filtration cloth belts wound for conveying and dehydrating the sludges between the drum and the caterpillar.

Further, dehydrated sludges remains in the form of small particles, and an apparatus for rinsing the filtration cloth belt is established at predetermined positions of the filtration cloth belt to remove them.

In the conventional dehydration apparatus, representative fixed type dehydration apparatus has been used, comprising conduits or high pressure hoses being connected thereto in order for the rinsing water to be supplied from a water pump, and a plurality of nozzles spraying the pumped rinsing water to the filtration cloth belt being established securely parallel to each other.

Further, in the fixed type dehydration apparatus, since the spray distance grows longer, the spray pressure is not only low, but also uneven washing is carried out by interferences between the rinsing water sprayed.

Therefore, since in order to accomplish more even washing, there should be increased the spray pressure, the number of rinsing or decreased the spray angle of the rinsing water and established a denser rinsing water spray nozzle, there have been disadvantages that it costs high for higher output or increasing the number of rinsing the water pump due to the increase of the spray pressure, or the equipment cost grows high for establishing more spray nozzle.

Therefore, improvements have been made, which solve the mentioned problems, on the spray nozzle allowing the rinsing water to be sprayed with its rotating at regular angles.

Although the rotation of the spray nozzle improves the rinsing power of the filtration cloth belt, the problem of blocking the spray nozzle by the wastes could not be improved, and the dependency only on high output power of the water pump for improving the rinsing power still exists.

In addition, constantly pure direct current is applied to between the drum and the caterpillar of the electro-osmotic dehydrator to form electric field, the water around charged liquid sludge particles in the electric field moves opposite electrode compared to the charges of the sludge particles by the electrophoresis and the capillary phenomena, and then the moisture is separated and removed.

That is, when, since the sludge particle carries (−) surface charges, electric field is formed in the sludge, the sludge particles move toward (+) electrode, and the moisture in the layer of the sludge particles moves toward (−) electrode, thereby promoting the dehydration.

The pure direct current (e.g., 60V) is applied to the dehydrator as described above, but since, as the dehydration time passes, the voltage loss increases greatly, the operating voltages decrease significantly (e.g., about 20˜25V), thereby degrading the dehydration performance.

In order to solve this problem, method comprising that three phase alternating current is rectified with each phase (R, S, T) to convert to DC voltage pulse, thereby permitting to apply stepwise voltages has been developed.

That is, an electro-osmotic dehydrator has been developed, characterized by that, during the dehydration, in order to maintain the regular voltage without voltage loss, after shorting the DC voltage at the time of voltage drop, DC voltage is again applied, such that DC voltage can be repeatedly applied with regular period to improve the dehydration performance by applying DC voltage pulse rectified with each phase (R, S, T) to the loads of the dehydrator.

However, the configuration, in which the voltages is applied to the loads of the dehydrator, comprises that (+) voltage is applied to the whole drum and (−) voltage is applied to the whole caterpillar.

Such power applying configuration has disadvantage in that the caterpillar rotated in the dehydrator exposed to pollutant sources is polluted by various pollutant material, so that electric short is frequently generated, and the dehydration performance degrades by the short of the power supply due to the pollute.

In addition, there are configurations that the voltages is applied only to the part of occurring dehydration. In this case, the electric power applying electrode is fixed type, and thus according to the amount of sludges, the electric power was not applied thereto.

That is, the drum and the filtration cloth belt compress the sludges in therebetween.

When the dehydration is carried out by the electrophoresis, but the amount of sludges is small, the filtration cloth belt is loosened, and thus the contact of the electrode is bad, such that it can not compensate the loosening space, and thereby applying power is impossible.

Further, the electric-osmotic dehydrator forms the electric field by applying constantly pure DC voltage between the drum and the caterpillar.

The water around the liquid sludge particles charged in the electric field moves toward opposite electrode compared to the charges of the sludge particles by electrophoresis and capillary phenomena, and then the moisture is separated and removed.

That is, when, since the sludge particles are carrying (−) surface charges, electric field is formed in the sludge, the sludge particles move toward (+) electrode, and the moisture in the layer of the sludge particles moves toward (−) electrode, thereby progressing the dehydration.

Although, in the above mentioned dehydrator, pure DC is applied thereto, while the sludges are separated into liquids and particles during the dehydration, electric resistance increases, the reason of which is the liquid part of the sludges is separated into liquids and particles, while the solid components remains.

The electric resistance increases by the solid components.

The concentration of hydrogen ion around (+) electrode increases due to the hydrogen ions (H+) generated from (+) electrode by electric decomposition of the liquid components of the sludges, thereby producing the problems in acidifying the remnant liquids.

This acidifying of the sludges and the remnant liquids produces the adverse effects in reducing the zeta potentials of the sludges particles, and eventually reducing the effects in separating of the liquids and the particles due to the appliance of electricity to the sludges.

The voltage loss increases greatly during the dehydration process, which significantly degrades the dehydration performance.

In order to overcome this, there needs an off-time during which the electricity is not applied in the meantime of separation into liquids and particles, or (+) and (−) electrodes are exchanged periodically using a frequency generator in place of conventional DC voltage so that the liquids and the particles become separated to thereby increase the dehydration efficiency of the sludges.

In the case of the latter, three phase alternating current is rectified with each phase (R, S, T) using diode, and is convert to DC voltage, thereby permitting to apply stepwise voltages has been developed, and therefore, during the dehydration, in order to maintain the regular voltage without voltages loss, after shorting the DC voltage at the time of voltage drop, DC voltage is again applied, such that DC voltage can be repeatedly applied with regular period.

However, optimal voltage is necessary according to the state of various sludges, in the case of the conventional dehydrator, the dehydration is progressed at constant voltage such that there have disadvantages in that the dehydration efficiency is minimized, or a transformer should be separately established to adjust the voltage, which costs high.

### DISCLOSURE

### Technical Problem

Accordingly, it is an object of this invention, which overcomes the above problems, to provide an electro-osmotic dehydrator configured as below.

(i) An electrode allowing voltage to be applied to a drum and a caterpillar comprises a spring and a graphite elastic supported by the spring, such that stable contact is possible regardless of the amount or constellation of the sludges, and even abrasions of the electrode are progressing, the contact maintains always constant, thereby persisting the function of dehydration.
(ii) Further, a phase control for three phase alternating current is possible with each phase to prevent the voltage drop during dehydration time, and even a large capacity of current is applied thereto, it can be used by dropping the voltage to various optimum voltages suitable for a constellation of sludges, such that various constellation of sludges can be dehydrated with a wide range of applications, thereby the present invention employs such phase control configurations for three phase alternating current.
(iii) In addition, after dehydrating sludges, there arise improvements of dehydration and energy efficiencies of an apparatus for rinsing a filtration cloth belt rinsing the filtration cloth belt used in the dehydration, a spray nozzle is rotated by regular angle right and left, and a rinsing water spray nozzle is configured to a spiral type nozzle to prevent the blocking of the nozzle.

### Technical Solution

To fully understand many objects to be accomplished by various embodiments and operational advantages of this invention, preferred embodiments of this invention will be described with reference to the accompanying drawings.

The present invention provides specified configurations to solve the above mentioned technical problems, which will be hereinafter described according to the each technical problem.

First, provided is a configuration of an electro-osmotic dehydrator in which electrode rods 5a and 5b are established for the purpose of stable application of the voltage of the drum 1 and the caterpillar 2.

Conventional electro-osmotic dehydrator comprises a drum 1 to which anode (+) or cathode (−) is applied, a caterpillar 2 spaced apart from the drum a and to which cathode (−) or anode (+) is applied, and two wound filtration cloth belts 4 between the drum 1 and the caterpillar 2 for conveying and dehydrating sludges 3.

In the dehydrator applying thereto a DC voltage by rectifying three phase alternating current, DC voltage pulses rectified in each phase (R, S, T) are applied.

That is, phase R, S and T of three phase alternating current are half wave rectified using rectifier element.

Half cycle of (+) of half wave rectified alternating current in each phase is stepwise flowed to become as full wave rectification to apply the current to the loeas of the dehydrator, i.e., drum 1 and caterpillar 2.

In particular, the first technical problem is the configuration of the electrode rods 5a and 5b that applies DC power source to the drum 1 and the caterpillar 2.

Hereinbelow, conventional applying configuration of three phase alternating current will be described first, and then the electrode rods 5a and 5b according to a characteristic aspect of the present invention will be described. Flowing half cycle of (+) rectified in each phase step by step is carried out smoothly by phase difference of each phase (R, S, T) in three phase alternating current.

The each phase (R, S, T) is connected to in between the two diodes connected in series in forward directions such that the current is controlled to flow in only one direction.

And the loads of the dehydrator is the drum 1 and the caterpillar 2 to which (+) and (−) or (−) and (+) are connected.

The term “forward direction” as described herein means that the order of two diodes in series is connected to an anode of another diode.

There illustrated various embodiments showing the configuration rectifying and applying three phase alternating current in each phase in FIGS. 1 and 2. FIG. 3 shows that DC voltages pulse half wave rectified in each phase (R, S, T) is connected to the drum 1 and the caterpillar 2, and forms an electric field by voltage difference to do a function of dehydration.

Three phase alternating current is rectified in each phase (R, S, T), and is supplied without applying DC voltage, where three phase alternating current is rectified in each phase (R, S, T), and DC voltage pulse rectified in each phase (R, S, T) is applied in order, thereby producing the effects as direct current, which is carried out smoothly by the phase difference in which each phase (R, S, T) of three phase alternating current has.

When three phase alternating current is applied in the form of voltage pulse rectified in each phase (R, S, T), conventional problems of voltage drop with time going on are overcome.

This regulates the voltage at the time of voltage drop to prevent the voltages drop, and applies immediately the pulse of another phase (R, S, T) for consecutive DC application to produce the effects in obtaining uniform linear pure DC appliance without voltage drop as a whole.

### Advantageous Effects

Due to a solution to the first technical problem, the electric power source is applied only to the dehydration part of the drum 1, and drum 1 of the caterpillar 2 wound with the drum 1 and producing the dehydration performance, such that the production of the electric field for dehydration is accurate, and the power source can be applied safely from the pollution of the dehydrator and the caterpillar 2, thereby increasing the dehydration performance, and when the caterpillar 2 is loosened according to the amount and constellation of sludges or is loosened by the abrasions of the graphite 8 itself of the electrode rods 5a and 5b, the graphite 8 of the electrode rods 5a and 5b compensate the loose space by the elasticity of the spring 7, thereby producing the effects in assuring the application of the electric power source.

Further, a plurality of electrode rods 5b is established throughout the whole area wound the drum 1 by the caterpillar 2 to thereby independently contact to the caterpillar 2, thereby having assuring charged means.

Due to a solution to the second technical problem, a rectifier circuit capable of adjusting the voltage and the circuit is added to the dehydrator, such that optimal dehydration voltage can applied according to the constellation of sludges to improve the dehydration performance, and a large amount of circuit can be applied, thereby producing the effects in drying with self-resistance of the sludges, and alternating to an optimal voltage suitable for the constellation or size of the sludges.

That is, this invention comprises a phase control unit for applying a dehydration voltage to the drum 1 and the caterpillar 2 with each phase of three phase alternating current, and a controller regulating the voltage applied by controlling the phase output from the phase control unit.

By controlling the phase through the control of the function of on/off and that of time by the controller, the level of the voltages and the current is regulated by a pulsating current of each rectified phase, and thus even a large capacitance of the voltage and the current is applied, it produces the effects in applying the optimal voltages and the current according to the constellation of sludges.

Therefore, there are optimal dehydration voltage suitable for the constellation of sludges, the present invention can change the voltage according to the sludges varied in the constellation with the dehydration process to apply, thereby increasing the effects in dehydration.

Due to a solution to the third technical problem, since this invention can uniformly apply the regular spray pressure of the rinsing water on the filtration cloth belt 4, uniform rinsing can be carried out compared to the conventional fixed type rinsing apparatus, thereby improving the rinsing and energy efficiency, and obtaining higher rinsing efficiency even with the employment of fewer rinsing water spray nozzle compared to the conventional fixed type rinsing apparatus, resulting in reducing the equipment cost.

Particularly, by employing spiral type spray nozzle, blocking of nozzle can be prevented by wastes, and the rinsing effect can be increased due to the fast effluence.

### DESCRIPTION OF DRAWINGS

This invention will be described in detail with reference to the accompanying drawings in which like numerals refer to like elements.

FIG. 1 shows an embodiment of schematic circuit diagram for an electro-osmotic dehydrator using three phase alternating current.

FIG. 2 shows another embodiment of schematic circuit diagram for an electro-osmotic dehydrator using three phase alternating current.

FIG. 3 shows applying DC pulse of each phase to an electro-osmotic dehydrator.

FIG. 4 shows a whole configuration view of an electro-osmotic dehydrator in accordance with one embodiment.

FIG. 5 shows a cross sectional view along line “A-A” of FIG. 4.

FIG. 6 shows a specified view of “B” part of FIG. 5.

FIG. 7 shows a specified view of “B” part of FIG. 6.

FIG. 8 shows a cross sectional view along line “D-D” of FIG. 5.

FIG. 9 shows a specified perspective view of “E” part of FIG.

FIG. 10 shows a specified cross sectional view of “E” part of FIG. 8.

FIG. 11 shows a perspective view illustrating establishment of an electrode rod.

FIG. 12 shows an exemplary view of phase control circuit.

FIG. 13 shows another exemplary view of phase control circuit.

FIG. 14 shows a comparative view of voltage drop according to rectified pulsating current and DC power source for three phase alternating current.

FIG. 15 shows a configuration view of a filtration cloth rinsing unit.

FIG. 16 shows a specified perspective view of primary part of a filtration cloth belt rinsing unit.

FIG. 17 shows an operation of a filtration cloth belt rinsing unit.

FIG. 18 shows a side view of rinsing water spray nozzle of main part of a filtration cloth belt rinsing unit.

### BEST MODE

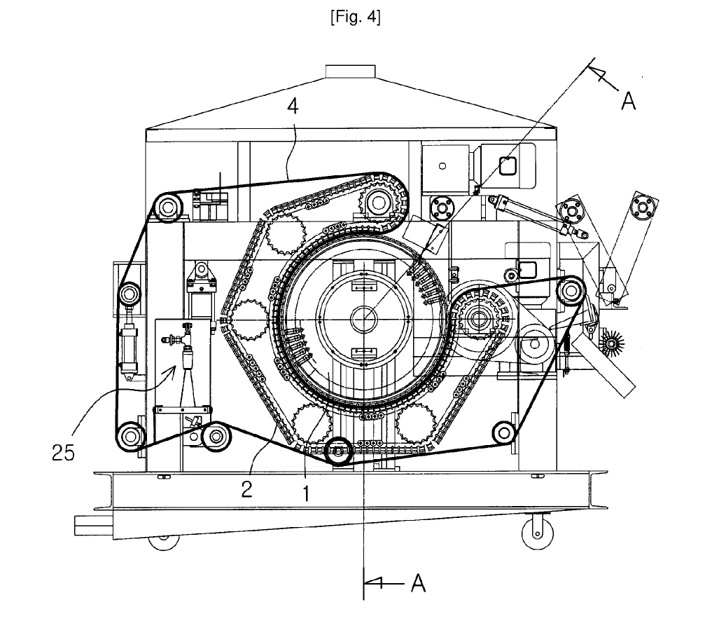

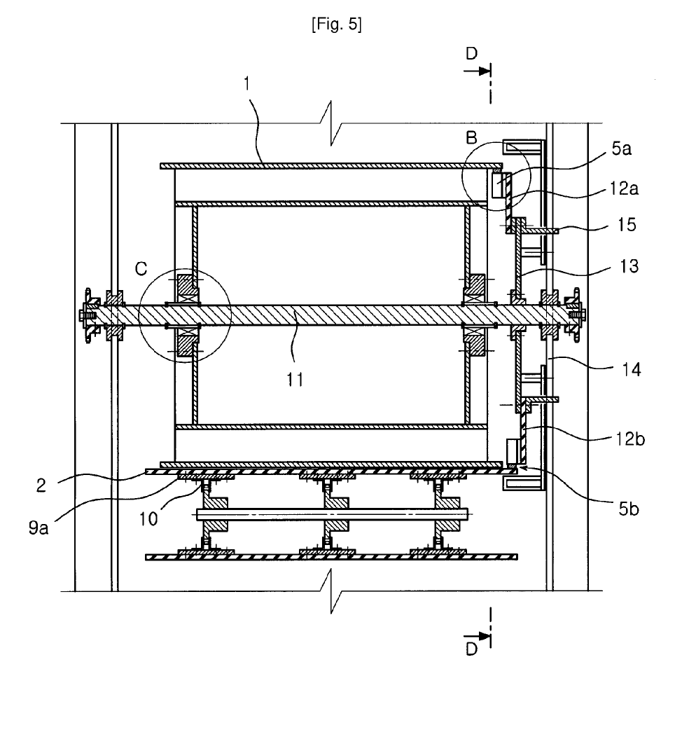

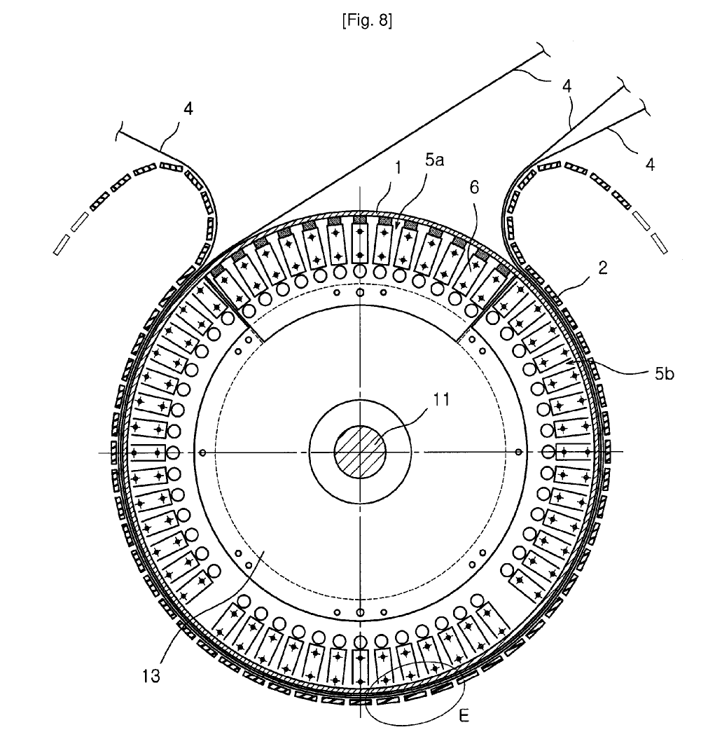

One embodiment of an electro-osmotic dehydrator, which rectifies the three phase alternating current into each phase (R, S, T) and then carries out the dehydration, is illustrated in FIG. 4. In FIGS. 5 to 11, the configurations of applying the power source to the drum 1 and the caterpillar 2 for accomplishing the first technical object of this invention are illustrated.

That is, the electro-osmotic dehydrator using three phase alternating current is connected in between the two diodes connected in series in forward direction established at each phase (R, S, T); the electrode rod 5a connected to the cathode of the diode contacts the drum 1, and (+) electrode of the pulse voltage half wave with each phase (R, S, T) of three phase alternating current rectified by the diode is applied to the whole drum 1; the electrode rod 5b connected to the anode of the diode contacts the caterpillar 2 wound to a cylindrical surface of the drum 1, (−) electrode is applied to the whole of the caterpillar 2.

The electrode rods 5a and 5b is configured in plurality, each of which is comprised of a graphite 8 elastic supported by a spring 7 established in a case 6. the caterpillar 2 is connected to a chain 10 rotating the caterpillar 2 via an insulator 9a, and the drum 1 is insulatingly secured by a drum shaft 11 and insulator 9b rotating the drum 1.

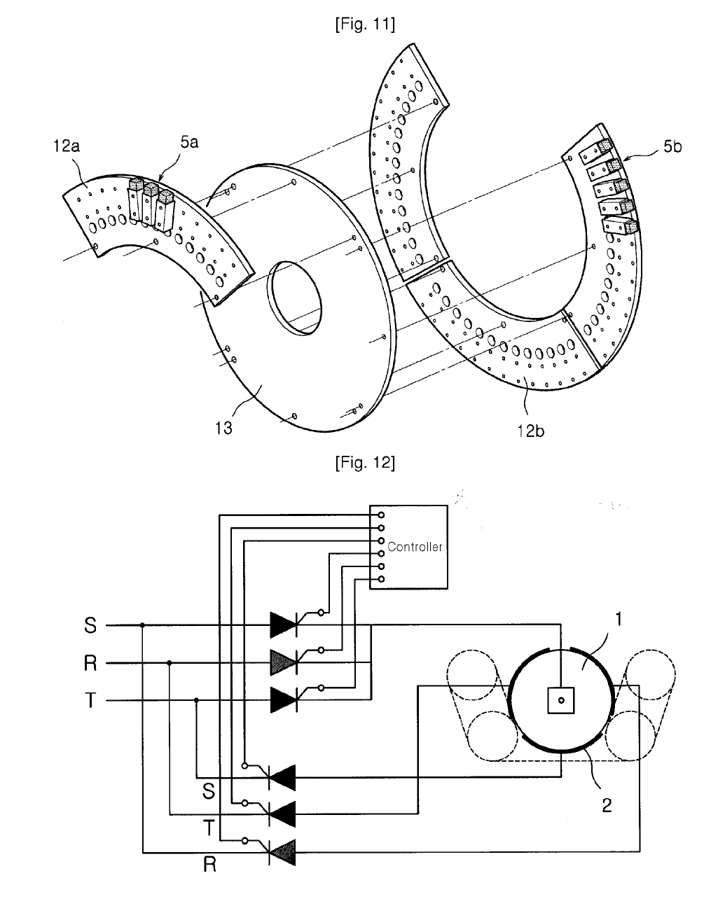

In particular, in applying power to the caterpillar 2, for the caterpillar 2 being wound with the drum 1 to produce the electric field to thereby apply it to the area functioning of dehydration, as depicted in FIG. 11, the electrode rod 5a is allowed to contact the circular drum 1, and for contacting the electrode rod 5b to the caterpillar 2 being wound with the drum 1, are electrode rod establishing plates 12a and 12b like a curvature of the cylindrical surface of the drum 1 is established to a circular fixed plate 13.

The fixing plate 13 supports the electrode rod establishing plate 12a and 12b, which can be established anywhere the electro-osmotic dehydrator is configured. That is, as depicted in FIG. 5, the fixed plate 13 can be established anywhere the fixed part of the electro-osmotic dehydrator is.

And the electrode rod establishing plates 12a and 12b can be established in such a manner as the establishing of the fixed plate 13 where the electro-osmotic dehydrator is configured, and the electrode rods 5a and 5b can be established at the configuration part of the electro-osmotic dehydrator.

Such establishing method is for the electrode rods 5a and 5b to contact to the drum 1 or the caterpillar 2, which can be selected and varied with the structure of the electro-osmotic dehydrator, which can also use a separate fixed plate bracket 15, is illustrated in FIG. 5.

When using the electrode rod establishing plates 12a and 12b, a plurality of electrode rod 5a connected to the drum 1 in the electrode rod establishing plate 12a, and the electrode rod 5b is secured only to winding part interacting with the drum 1 and the caterpillar 2.

Since the electrode rod establishing plate 12a is to contact the electrode rod 5a to the drum 1, the size thereof is smaller than that of the electrode rod establishing plate 12b.

That is, the size of arc of the electrode rod establishing plate 12b is determined by the size of arc for the caterpillar to be wound to the drum 1, and the remaining part becomes the size of the electrode rod establishing plate 12a, such that when the electrode rod establishing plate 12b, the whole becomes one circular shape.

Of course, the electrode rod establishing plates 12a and 12b can be secured to the electro-osmotic dehydrator, but as in FIG. 5, secured to the fixed plate 13, and makes the fixed plate 13 be fixed an optimal position of the electro-osmotic dehydrator. However, it is easy to secure where the drum shaft 11 of the electro-osmotic dehydrator is supported.

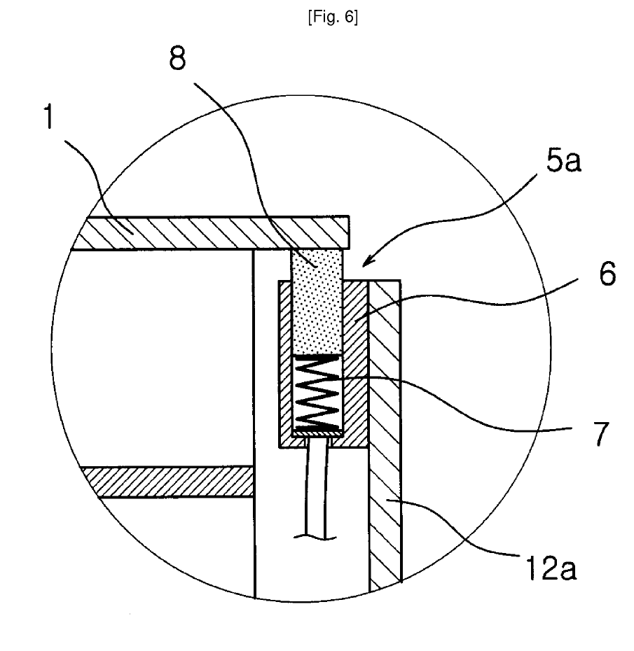

The dehydrator of this invention as configured above is illustrated in FIGS. 4 and 5, and the configuration that the power is applied to the drum 1 and the caterpillar 2 is illustrated in FIGS. 6, 7 and 9.

Where, the characteristic features of this invention lie in the configure of the electrode rods 5a and 5b, which comprises the graphite 8 supported by the spring 7.

Since the voltage is applied by contacting the graphite 8 to the drum 1 and the caterpillar 2, even the graphite 8 gets abrasive in use, the spring 7 supports the graphite 8, such that the electrode rods 5a and 5b can function as electrodes.

Therefore, even the caterpillar 2 gets loosened, the graphite 8 of the electrodes 5a and 5b compensate the loose space by the elasticity of the spring 7, such that it can apply the power assuredly, thereby accomplishing stable appliance of voltage without the amount of sludges.

Further, a plurality of electrode 5b is established over the whole area winding the drum by the electrode rod 5b, such that each contacts the caterpillar 2 to have charged means.

The sludges 3 to be dehydrated, as in FIG. 4, is inlet to between the filtration cloth belt 4 to convey along the drum 1, while dehydrated in between the drum 1 and the caterpillar 2.

In this case, preferably (+) and (−) are applied to the drum 1 and caterpillar 2, but is not limited thereto.

DC voltage pulse of (+) in which three phase alternating current is rectified in each phase (R, S, T) is applied to the drum 1 by the electrode rod 5a, which is specifically depicted in FIGS. 6, 7, 9 and 12.

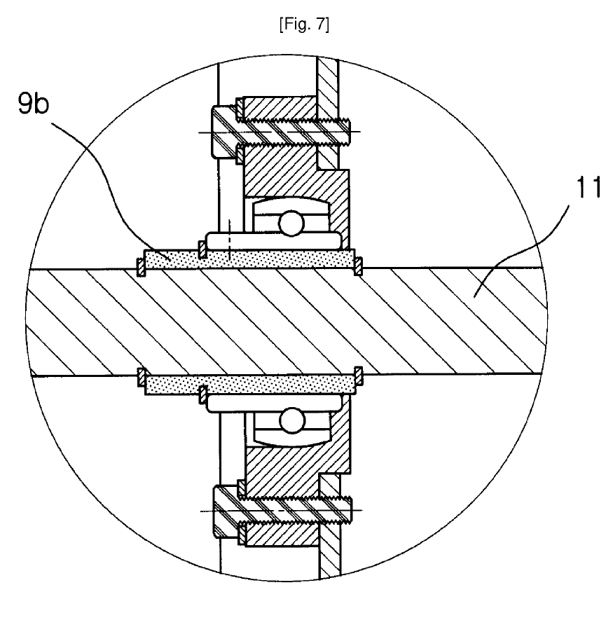

Further, the drum 1 and the drum shaft rotating the drum 1 are insulated by the insulator 9b in order for (+) voltage applied to the drum 1 not to be conducted to the whole of dehydrator, which is depicted in FIG. 7.

Such configuration enables (+) voltage to be applied to the whole of the drum 1.

In addition, voltage (−) is applied to the caterpillar 2 wound to the drum 1 and moving on infinite track relative to the drum 1.

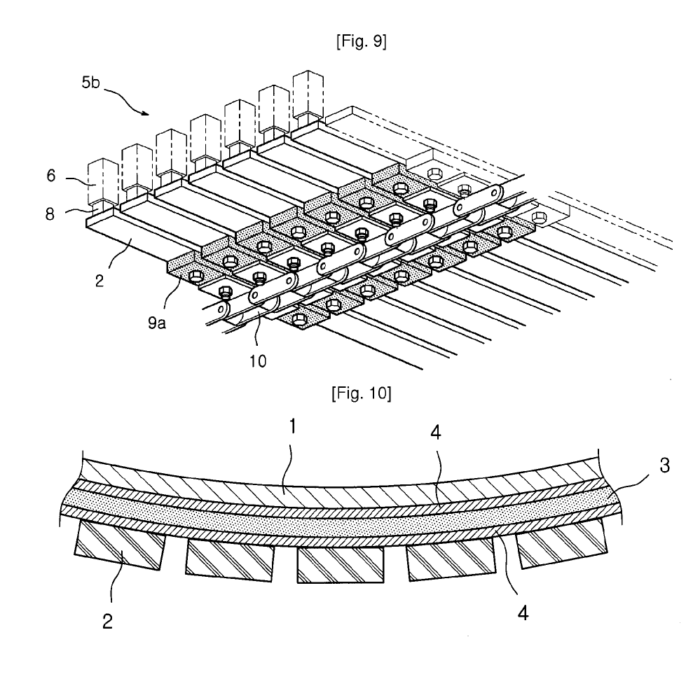

As depicted in FIGS. 5 and 9, a plurality of electrode rod 5b contacts the caterpillar 2.

The power is not applied to the whole of caterpillar 2, but is applied only to where the electric field is necessary for dehydration and wound to the drum 1.

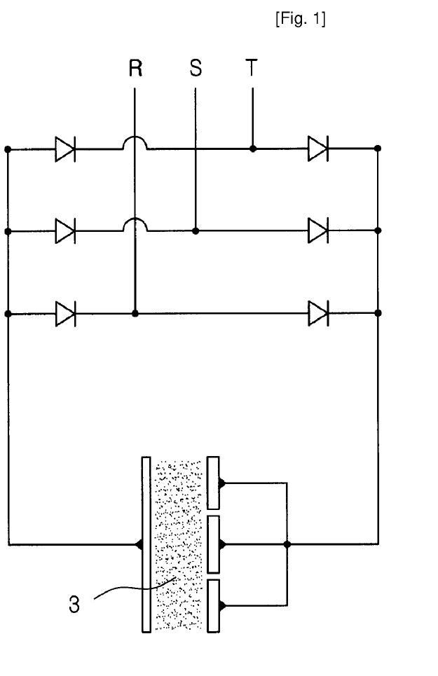

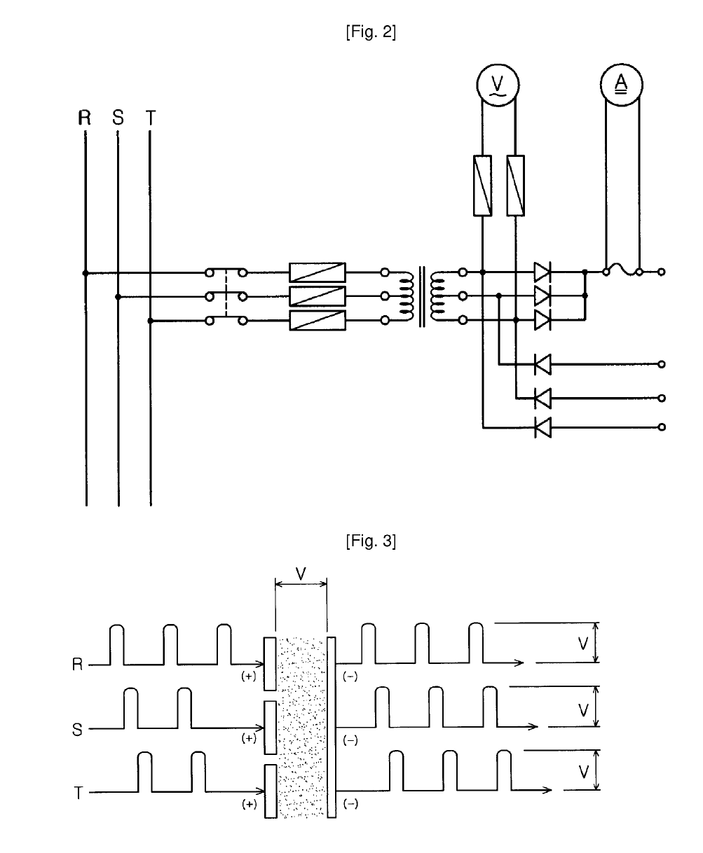

The sludges 3 are dehydrated in between the drum 1 and the caterpillar 2 by the electric field through the application of the voltage, which is specifically depicted in FIGS. 1 and 3, is formed by the (+) and (−) of the DC pulse voltage.

That is, as depicted in FIG. 3, DC voltage pulse is applied to the drum 1 in order by the phase difference in each phase (R, S, T), and the half wave DC voltage pulse rectifying the each phase (R, S, T) of the three phase alternating current is sequentially applied to at time interval of the phase difference of the alternating current, thereby shorting the pure DC to function as repetitive appliance thereto.

When the continuous pure DC voltage is applied the drum 1 and the caterpillar 2, as the dehydration time goes by, the voltage drop is occurred thereby degrade the dehydration performance.

However, when the three phase alternating current is rectified and is applied thereto, in the voltage drop's occurring, the voltage becomes short, and since that the same dehydration performance is performed all the time without degradation of the dehydration performance.

Next, provided is a phase control type electro-osmotic dehydrator in accordance with the technical object of this invention that an optimal voltage variable from high voltage to low voltage can be applied according to the constellation of the sludge 3.

That is, the present invention rectifies the three phase alternating current in each phase in the drum 1 and the caterpillar 2 to supply the pulsating current to be able to control the each phase.

In rectifying each phase (R, S, T) of the three phase alternating current, each phase (R, S, T) of the three phase alternating current is controlled by the voltage and the current by the phase control circuit configured by SCR (Silicon Control Rectifier) or TRIAC and equivalent circuit thereof, thereby being rectified in pulsating current to be output.

The phase control circuit comprised of the SCR, TRIAC and equivalent circuit thereof half wave rectifies or full wave rectifies the alternating current.

(+) part of the alternating current rectified in each caterpillar 2 to be partitioned in three portions, in which the loads of the dehydrator is the drum 1 connected by (+) and the caterpillar 2 connected by (−).

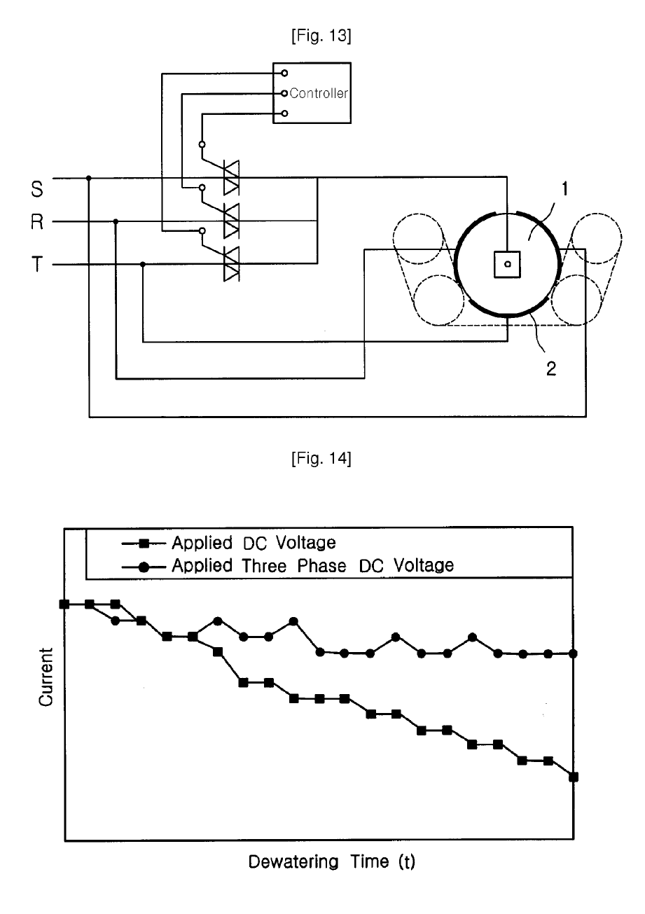

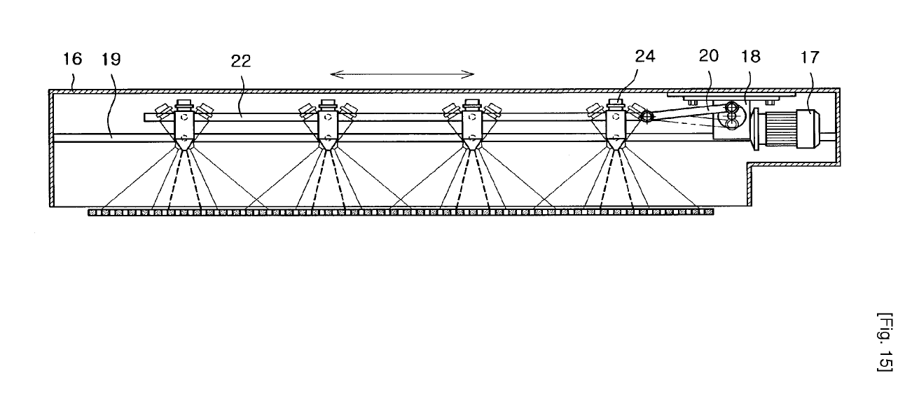

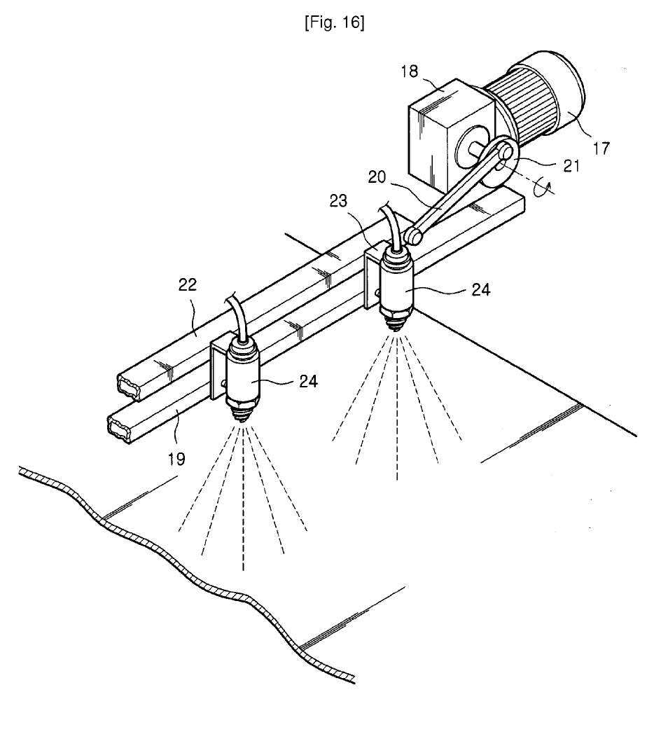

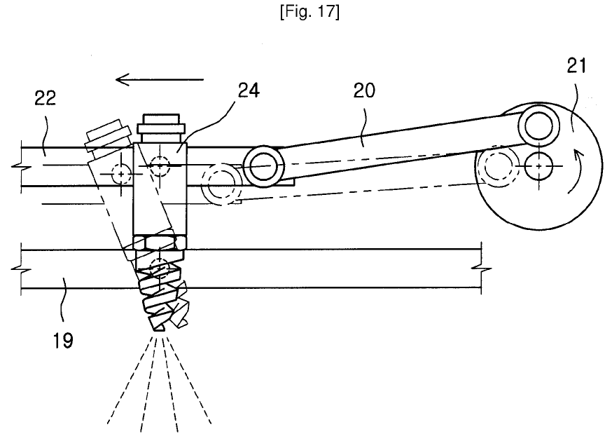

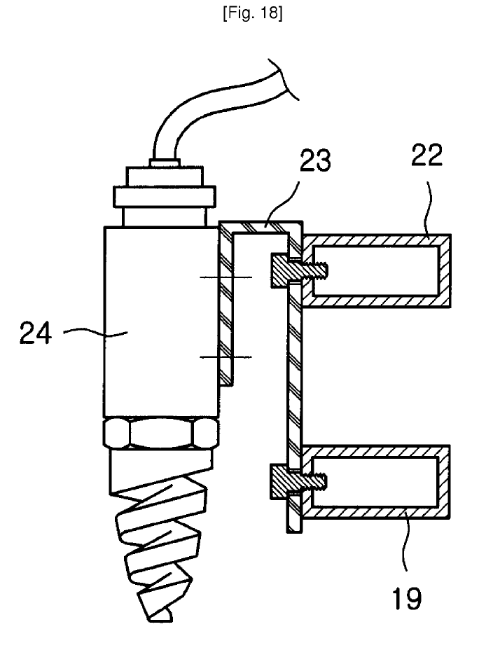

The configuration that the pulsating current is applied to the drum a and the caterpillar 2 by rectifying of the three phase alternating current is depicted in FIGS. 12 and 13.

The three phase alternating current is rectified to apply to the power source for dehydration, in which a rectifying circuit can regulate the voltage and the current.

FIG. 12 illustrates an embodiment that the dehydration voltage is applied to the drum 1 and the caterpillar 2 by half wave rectifying using SCR, and FIG. 13 illustrates a configuration that the dehydration voltage is applied to the drum 1 and the caterpillar 2 by full wave rectifying using TRIAC.

Therefore, the level of voltage and current is regulated by the pulsating current of each phase output controlled, by controlling the phase through the control of on/off function and the control of time in the controller.

Even the input current of three phase alternating current needs small amount of current by a controllable voltage and current employs a large capacity of current, the current can be used by decreasing the amount thereof whenever necessary, such that the current the voltage can be varied in various constellation of sludges 3 for use.

That is, the sludges 3 to be dehydrated have various constellations, in order to increase the dehydration efficiency in each constellation of the sludge 3, voltage suitable for a constellation of sludges 3 are required.

Therefore, this invention comprises a phase control element in which the voltage and the current such as SCR or TRIAC are controllable, thereby carrying out a most efficient function of dehydrating the sludges 3.

Contrary to the above, the conventional apparatus could not perform ideal dehydration function by using the diode rectifying the fixed voltage and current, and could not apply the large capacity of current.

Finally, means for slowing the technical object is to provide an electro-osmotic dehydrator in order to increase the dehydration efficiency, to improve the energy efficiency, to reduce the equipment cost, and to prevent the blocking of the spray nozzle to a spiral type nozzle.

While the sludges 3 are uniformly distributed in between the filtration cloth belts 4, a plurality of rollers are rotated to extract to thereby ejecting a cake dehydrated from the sludges to rear end of this unit.

The filtration cloth belt rinsing unit 25 is established on predetermined position on a track of the filtration cloth belt 4 rotated in an endless formation.

The electro-osmotic dehydrator will be described based on the filtration cloth belt rinsing unit 25, which comprises a frame 16 transversely disposed in intersecting direction of the filtration cloth belt 4 on the track of the filtration cloth belt 4; a fixing rod 19 securely established to both side walls of a motor 17 and the frame 16 installed at the inner ceiling of the frame 16; a moving rod 22 fin coupled with a position of periphery of a circular disc 21 from a decelerator 18 by a connecting rod 20; a nozzle bracket 23 fin coupled in its upper and lower part to rotate in the moving rod 22 and the fixing rod 19; and a plurality of rinsing water spray nozzle 24 attached to the nozzle bracket 23.

While the sludges 3 are uniformly distributed in between the filtration cloth belts 4, the filtration cloth belts 4 rotate a plurality of rollers by way of electrophoresis in order the dehydrated sludges 3 to become cakes, thereby being ejected to the end of the dehydration apparatus.

The filtration cloth belt 4 is rotated in endless formation, and is conveyed to the filtration cloth belt rinsing unit 25.

The frame 16 of the filtration cloth belt rinsing unit 25 is established in intersecting direction of the filtration clith belt 100.

In operating the water pump and the motor 17, the rinsing water is sprayed from the nozzle 24, and rinsing the filtration cloth belt 4, while the rotation movement of the rotating disc 21 rotated by the decelerator 18 is changed to reciprocal movement to be transferred to the moving rod 22 in reciprocal movement.

In this case, since the upper part of the nozzle bracket 23 fixing the rinsing water spray nozzle 24 is fin coupled with the moving rod 22, and the lower part thereof is fin coupled with the fixing rod 19 secured to the frame 16, when the moving rod 22 exercises reciprocal movement, the nozzle bracket 23 is rotated right and left at the center of fin coupling point with fixing rod 19 in the lower part thereof, such that the rinsing water spray nozzle 24 is also related right and left by the same angles, thereby the rinsing water can be sprayed to the space between the rinsing water spray nozzle 24 over the filtration cloth belt 4 at regular water pressure in spraying the rinsing water.

In particular, the characteristic feature of this invention lies in employing the rinsing water spray nozzle 24 as a spiral type nozzle, thereby preventing the nozzle from blocking due to the wastes (water scale), and obtaining a fast discharge, high energy efficiency and various spray angles.

1. An electro-osmotic dehydrator comprising a cathode (or a anode) of DC voltage applied to a drum 1 and a anode (or a cathode) of DC voltage applied to caterpillar 2 wound on cylinder surface, characterized by that a plurality of electrode rod 5a is established in contact with an interior surface of the drum 1, and a plurality of electrode rod 5b is established in contact with along a curvature of the caterpillar 2 where the drum 1 meets.

2. An electro-osmotic dehydrator as defined in claim 1, the electrode rods 5a and 5b comprise a case 6, a spring 7 established in the case 6, a graphite 8 elastic supported by the spring 7.

3. An electro-osmotic dehydrator as defined in claim 1, the caterpillar 2 is intermediated with an insulator 9a and is connected with a chain 10 rotating the caterpillar 2.

4. An electro-osmotic dehydrator as defined in claim 1, the drum 1 is insulatively secured to a drum shaft 11, rotating the drum 1, via an insulator 9b.

5. An electro-osmotic dehydrator, which comprises a rinsing water spray nozzle 24 established over a portion of track of a filter cloth belt 4 ejecting a dewatered sludgy 3, wherein the rinsing water spray nozzle 24 is a spiral type nozzle.

6. An electro-osmotic dehydrator in which three phase alternating current is rectified with each phase to be applied to a drum 1 and a caterpillar 2, characterized by that a phase control device, which is selected from the group of phase control circuit consisting of an equivalent current of SCR, TRIAC, SCR or TRIAC, and a controller of controlling the phase output from the phase control device are established, between each of the three phase alternating current, and the drum 1 and the caterpillar 2, and the each phase of the three phase alternating current is output to a pulsating current in which a voltage and a current are adjusted to thereby be applied to the drum 1 and the caterpillar 2.
